(19) United States
(12) Patent Application Publication
(10) Pub. No.: US 2010/0091006 A1
(43) Pub. Date: Apr. 15, 2010

(54) Organic light emitting display device and method of driving the same

(75) Inventors: Myoung-Hwan Yoo, Suwon-si (KR); Keum-Nam Kim, Suwon-si (KR)

Correspondence Address: ROBERT E. BUSHNELL & LAW FIRM, 2029 K STREET NW, SUITE 600, WASHINGTON, DC, 20006-1004, US

(73) Assignee: Samsung Mobile Display Co., Ltd., Yongin-City (KR)

(21) Appl. No.: 12/585,891

(22) Filed: Sep. 28, 2009

(30) Foreign Application Priority Data
Oct. 13, 2008 (KR) 10-2008-0100086

(51) Int. Cl. G06F 3/038

(52) U.S. Cl. 345/213

(57) ABSTRACT

An organic light emitting display device capable of compensating for the threshold voltage and mobility of a driving transistor. The organic light emitting display device includes a pixel unit having a plurality of pixels formed at intersection areas of data and scan lines; a scan driving unit sequentially supplying a scan signal to the scan lines; a data driving unit supplying data signals to the data lines; a power supply unit outputting a high-potential pixel power source, a low-potential compensation power source and a low-potential ground power source to drive the pixels; and a power control unit supplying the compensation power source supplied from the power supply unit to the pixel unit during a first period (black frame period) of each frame, and supplying the pixel power source supplied from the power supply unit to the pixel unit during a second period (display frame period) of each of the frames.

### CLAIM OF PRIORITY

This application makes reference to, incorporates the same herein, and claims all benefits accruing under 35 U.S.C. §119 from an application for ORGANIC LIGHT EMITTING DISPLAY DEVICE AND METHOD OF DRIVING THE SAME earlier filed in the Korean Intellectual Property Office on the 13 Oct. 2008 and there duly assigned Serial No. 10-2008-0100086.

### BACKGROUND OF THE INVENTION

1. Field of the Invention

The present invention relates to an organic light emitting display device and a method of driving the same, and more particularly, to an organic light emitting display device capable of compensating for the threshold voltage and mobility of a driving transistor, and a method of driving the same.

2. Description of the Related Art

Recently, there have been various types of flat panel display devices having less weight and volume than cathode ray tubes. The flat panel display devices include a liquid crystal display device, a field emission display device, a plasma display panel, an organic light emitting display device, and the like.

Among these flat panel display devices, the organic light emitting display device displays images using organic light emitting diodes (OLEDs) that emit light through the recombination of electrons and holes. The organic light emitting display device has a fast response speed and is driven with low power consumption.

Generally, an organic light emitting display device expresses gray scales while controlling an amount of current flowing through organic light emitting diodes using driving transistors included in respective pixels. In this case, there is a problem in that an image having unequal luminance is displayed due to a threshold voltage variation and a mobility (mobility of electrons or holes) variation of the driving transistors included in the respective pixels.

In order to solve such a problem, Korean Patent Publication No. 10-2007-0112714 has disclosed a method for compensating for the threshold voltage and mobility of a driving transistor while changing the potential of a first power source supplying current to an organic light emitting diode from a high potential to a low potential.

However, in the patent publication, the potential of the first power source is changed in such a manner that a power source is scanned by a power source scanner. Therefore, a high-capacity buffer is designed to be coupled to an output terminal of the power source scanner, and all current supplied through one line are controlled by the buffer. For this reason, there is a limit in applying the method depending on the size and resolution of a panel.

Further, when a power source scanner is designed in a panel, a circuit component such as a filter for changing the potential of a first power source is added to the panel. Since high heat is generated from the panel, a heat sink or the like is added to the panel.

### SUMMARY OF THE INVENTION

Accordingly, it is an object of the present invention to provide an organic light emitting display device and a method of driving the same, wherein a high-potential pixel power source or a low-potential compensation power source is supplied to a first power supply line of a panel from the outside of the panel, so that the threshold voltage and mobility of a driving transistor can be compensated without using a power scan method.

According to an aspect of the present invention, there is provided an organic light emitting display device, including a pixel unit having a plurality of pixels formed at intersection areas of data and scan lines; a scan driving unit sequentially supplying a scan signal to the scan lines; a data driving unit supplying data signals to the data lines; a power supply unit outputting a high-potential pixel power source, a low-potential compensation power source and a low-potential ground power source to drive the pixels; and a power control unit supplying the compensation power source supplied from the power supply unit to the pixel unit during a first period (black frame period) of each frame, and supplying the pixel power source supplied from the power supply unit to the pixel unit during a second period (display frame period) of each of the frames.

The scan driving unit may supply a scan signal to the scan lines in the first and second periods, respectively. The data driving unit may supply black data signals to the data lines for each of the first periods and supply display data signals to the data lines for each of the second periods.

The pixel unit may be provided in a panel, and the power supply unit and the power control unit may be provided in a module formed at the outside of the panel. The power control unit may alternately supply the pixel power source and the compensation power source through a first power supply line coupled between the pixel unit and the power control unit.

The power control unit may include first and second transistors coupled in series between the pixel power source and the compensation power source from the power supply unit, and receive a common control signal through gate terminals of the first and second transistors. The first and second transistors may be set as opposite types of transistors and alternately turned on in response to the control signal.

According to another aspect of the present invention, there is provided a method of driving an organic light emitting display device, which includes storing a threshold voltage of a driving transistor in each of the pixels while supplying a scan signal, a black data signal, a low-potential ground power source and a low-potential compensation power source to pixels during a first period (black frame period) of a frame; and displaying an image corresponding to the display data signal while supplying a scan signal, a display data signal, the ground power source and a high-potential pixel power source to the pixels during a second period (display frame period) of the frame.

The compensation power source or the pixel power source may be simultaneously supplied to the pixels from the outside of a panel.

According to the present invention, a power control unit provided at the outside of a panel alternately supplies a high-potential pixel power source and a low-potential compensation power source through a first power supply line. Accordingly, the threshold voltage and mobility of a driving transistor can be compensated without using a power scan method.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of an organic light emitting display device according to an embodiment of the present invention;

FIG. 2 is a circuit diagram showing an embodiment of a pixel and a power control unit, shown in FIG. 1;

FIG. 3 is a waveform diagram illustrating a method of driving the pixel and the power control unit, shown in FIG. 2 and

FIGS. 4A to 4C are circuit diagrams illustrating a process of driving the pixel and the power control unit, shown in FIG. 2.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

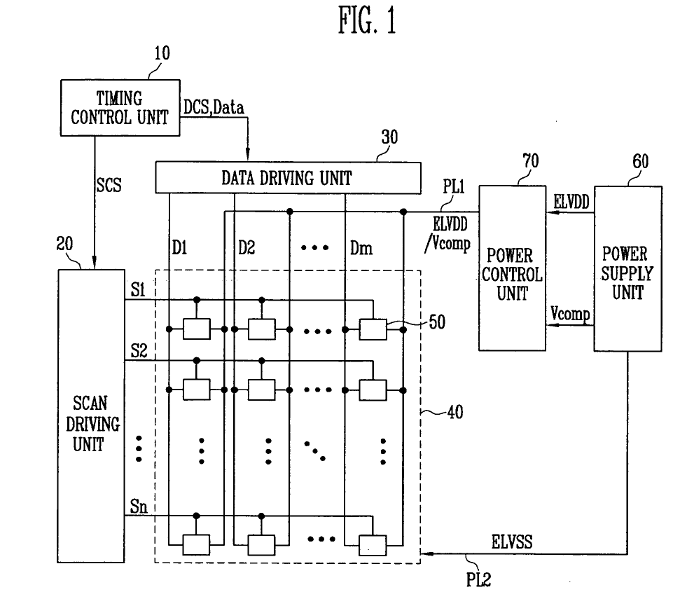

FIG. 1 is a block diagram of an organic light emitting display device according to an embodiment of the present invention.

Referring to FIG. 1, the organic light emitting display device according to the embodiment of the present invention includes a timing control unit 10, a scan driving unit 20, a data driving unit 30, a pixel unit 40, a power supply unit 60 and a power control unit 70.

The timing control unit 10 generates a scan driving control signal SCS and a data driving control signal DCS in response to synchronization signals externally supplied to the organic light emitting display device. The scan driving control signal SCS generated from the timing control unit 10 is supplied to the scan driving unit 20, and the data driving control signal DCS is supplied to the data driving unit 30. The timing control unit 10 supplies externally supplied data “Data” to the data driving unit 30.

In the organic light emitting display device of the present invention, a frame is divided into a first period and a second period. Here, the first period is a period in which the threshold voltage of a driving transistor is stored while each pixel does not emit light in response to a black data signal. The second period is a period in which an image is displayed in response to a display data signal. The second period may be subsequent to the first period. Hereinafter, the first and second periods will be referred to as a black frame period and a display frame period, respectively.

When one frame is divided into a black frame period and a display frame period, the timing control unit 10 controls the scan driving unit 20 and the data driving unit 30 so that scan and data signals can be supplied to the pixel unit 40 for each of the black frame period and the display frame period.

Meanwhile, assuming that each of the black and display frame periods is a separate frame, it will be apparent that a black frame period is inserted between respective display frame periods.

The scan driving unit 20 drives scan lines, S1 to Sn while sequentially supplying a high-level scan signal to the scan lines S1 to Sn. When a scan signal is sequentially supplied to the scan lines S1 to Sn, pixels 50 are sequentially selected by the row. However, in the embodiment of the present invention, the scan driving unit 20 sequentially supplies a scan signal to the scan lines S1 to Sn for each of the black and display frame periods in the frame.

The data driving unit 30 drives data lines D1 to Dm while supplying data signals to the data lines D1 to Dm. Particularly, the data driving unit 30 of the present invention supplies black data signals to the data lines D1 to Dm for a black frame period of each frame and supplies display data signals to the data lines D1 to Dm for a display frame period of each of the frames. Here, the display data signals correspond to an image to be displayed during the corresponding frame.

The pixel unit 40 includes a plurality of pixels 50 formed at intersection areas of the scan lines S1 to Sn and the data lines D1 to Dm.

Each of the pixels 50 is coupled to scan and data lines S and D respectively positioned in horizontal and vertical lines of its own pixel. Each of the pixels 50 receives scan and data signals respectively supplied from the scan and data lines S and D. The pixels 50 alternately receive a compensation power source Vcomp and a pixel power source ELVDD supplied from a power supply line PL1, and receives a ground power source ELVSS supplied from a power supply line PL2.

Here, the potential of the pixel power source ELVDD is set as a high-potential power source, and the compensation power source Vcomp and the ground power source ELVSS are set as low-potential power sources. Particularly, the potential of the compensation power source Vcomp is a potential at which the threshold voltage of a driving transistor (not shown) included in each of the pixels 50 can be stored in the pixel 50 for each of the black frame periods. The potential of the compensation power source Vcomp may easily be experimentally determined.

The pixels 50 store the threshold voltage of a driving transistor while not emitting light for a black frame period of one frame, and they emit light at a luminance corresponding to a display data signal for a display frame period of the one frame. A more detailed description will be described later.

The power supply unit 60 outputs the pixel power source ELVDD, the compensation power source Vcomp and the ground power source ELVSS to drive the pixels 50. The power supply unit 60 supplies the pixel power source ELVDD and the compensation power source Vcomp to the power control unit 70, and supplies the ground power source ELVSS to the pixel unit through the power supply line PL2.

The power control unit 70 supplies the pixel power source ELVDD and the compensation power source Vcomp to the pixel unit 40 through the power supply line PL1. Particularly, the power control unit 70 supplies the compensation power source Vcomp to the pixel unit 40 through the power supply line PL1 for each of the black frame periods, and supplies the pixel power source ELVDD to the pixel unit 40 through the power supply line PL1 for each of the display frame periods subsequent to the respective black frame periods.

In the embodiment of the present invention, the power supply unit 60 and the power control unit 70 are not provided in a panel having the pixel unit 40 but provided in a module formed at the outside of the panel, so that the pixel power source ELVDD, the compensation power source Vcomp and the ground power source ELVSS are supplied to the pixel unit 40 through the power supply lines PL1 and PL2.

The power control unit 70 alternately supplies the pixel power source ELVDD and the compensation power source Vcomp to the pixel unit 40. Particularly, the power control unit 70 simultaneously supplies the pixel power source ELVDD or the compensation power source Vcomp to pixels 50 positioned on each line of the pixel unit 40 through the power supply line PL1 coupled between the pixel unit 40 and the power control unit 70. Here, the term “simultaneously” has a meaning expressed without consideration of a voltage drop generated in the panel, and the like.

That is, in the present invention, the pixel power source ELVDD and the compensation power source Vcomp are supplied to all the pixels 50 through the power supply line PL1 from the power control unit 70, without using a method of scanning power sources of pixels 50 for each line. Accordingly, it is not necessary to design a high-capacity buffer in the panel, and the present invention can be applied regardless of the size and resolution of the panel. Further, the power control unit 70 and the like are provided to the outside of the panel, so that it is possible to prevent the panel from being damaged due to heat or the like.

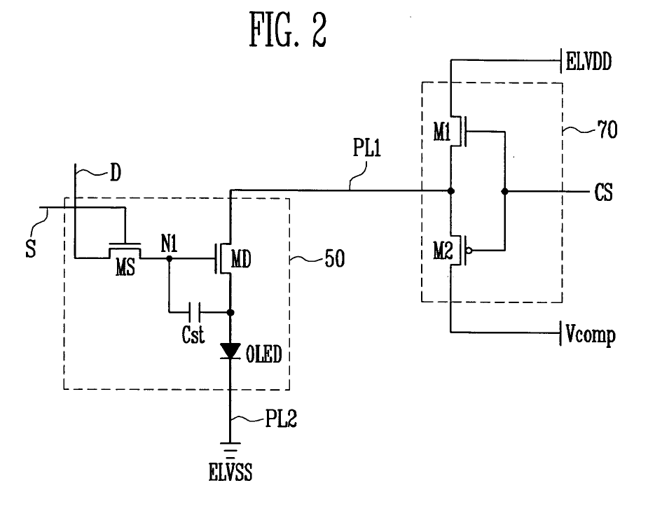

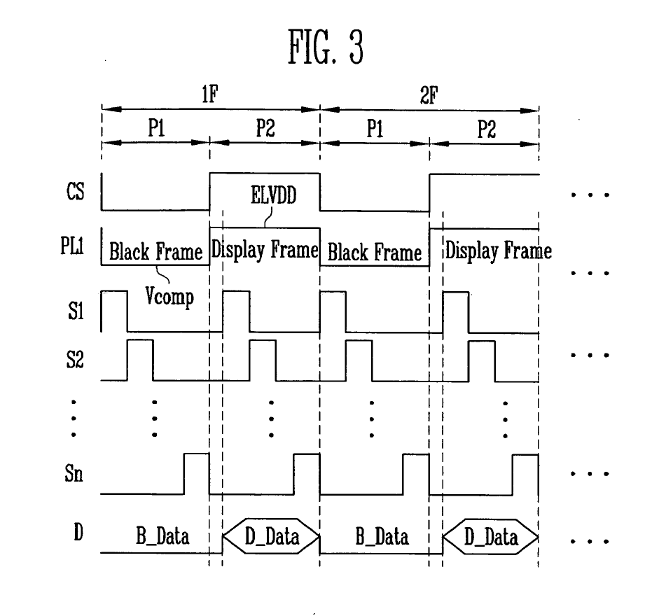

FIG. 2 is a circuit diagram showing an embodiment of a pixel and a power control unit, shown in FIG. 1. FIG. 3 is a waveform diagram illustrating a method of driving the pixel and the power control unit, shown in FIG. 2.

Referring to FIG. 2, the pixel 50 includes an organic light emitting diode OLED coupled between power supply lines PL1 and PL2; a driving transistor MD coupled between the power supply line PL1 and the organic light emitting diode OLED; a storage capacitor Cst coupled between a first node N1 coupled to a gate electrode of the driving transistor MD and a source electrode of the driving transistor MD; and a switching transistor MS coupled between a data line D and the first node N1 and having a gate electrode coupled to a scan line S.

Here, source and drain electrodes of the driving transistor MD are determined depending on voltages applied to the two electrodes. The source and drain electrodes of the driving transistor MD may be set different in the black frame period and the display frame period. However, for convenience of illustration, will be consistently described below by assuming that one electrode of the driving transistor MD coupled to the organic light emitting diode OLED is a source electrode based on the display frame period.

As shown in FIGS. 2 and 3, the pixel 50 receives a scan signal, a black data signal B_Data, a compensation power source Vcomp and a ground power source ELVSS respectively supplied through corresponding scan line S, corresponding data line D, power supply line PL1 and power supply line PL2 during a black frame period P1 of one frame. At this time, a threshold voltage of the driving transistor MD is stored in the storage capacitor Cst.

Thereafter, the pixel 50 receives a scan signal, a display data signal D_Data, a pixel power source ELVDD and a ground power source ELVSS respectively supplied through the corresponding scan line S, the corresponding data line D, the power supply line PL1 and the power supply line PL2 during a display frame period P2. Accordingly, the pixel 50 emits light at a luminance corresponding to the display data signal D_Data, thereby displaying an image in the pixel unit 40. A detailed operation of the pixel 50 will be described later.

Since the threshold voltage of the driving transistor MD was stored in the storage capacitor Cst during the previous black frame period P1, a uniform image can be displayed during the display frame period P2, regardless of the threshold voltage variation of the driving transistors MD between the pixels 50.

Further, since black frame periods P1 are inserted between respective display frame periods, motion blur is prevented. Here, the black frame period P1 is a period in which the entire pixel unit 40 displays black, and the motion blur is a phenomenon in which an image is visually blurred. Accordingly, a clear image can be displayed.

Here, times of the black frame period P1 and the display frame period P2 may be set different so that one frame is effectively used. That is, the black frame period P1 may be set shorter than the display frame period P2, so that a scan operation through the scan lines S1 to Sn can be performed at a high speed during the black frame period P1.

As shown in FIG. 2, the power control unit 70 includes transistors M1 and M2 coupled in series between the pixel power source ELVDD and the compensation power source Vcomp. Here, gate electrodes of transistors M1 and M2 are coupled to the same input line and receive a common control signal CS.

Transistors M1 and M2 are set as opposite types of transistors. For example, transistor M1 may be set as an n-type transistor, and transistor M2 may be set as a p-type transistor. Accordingly, transistors M1 and M2 alternately output the pixel power source ELVDD and the compensation power source Vcomp to the power supply line PL1 while being alternately turned on in response to the control signal CS.

Here, the control signal CS may be supplied to the power control unit 70 from an external circuit such as a timing control unit. The control signal CS is set so that a low-potential compensation power source Vcomp is outputted to the power supply line PL1 in the black frame period of FIG. 3, and a high-potential pixel power source ELVDD is outputted to the power supply line PL1 in the display frame period of FIG. 3.

For example, when transistors M1 and M2 are set as n-type and p-type transistors, respectively, the control signal CS may be set so that low-potential and high-potential power sources are outputted in the black frame period P1 and the display frame period P2, respectively.

Meanwhile, transistors M1 and M2 may all be formed as metal oxide semiconductor field-effect transistors (hereinafter, referred to as “MOSFETs”). Generally, MOSFETs have a large current capacity. Therefore, when transistors M1 and M2 are formed as MOSFETs, the power control unit 70 can be simply configured, and the pixel power source ELVDD or compensation power source Vcomp can be easily outputted to the power supply line PL1.

Hereinafter, a process of driving the pixel and the power control unit, shown in FIG. 2, will be described in detail in conjunction with FIGS. 2, 3 and 4A to 4C.

First, transistor M2 of the power control unit 70 is turned on by a low-potential control signal CS during a black frame period P1 of each frame, and a low-potential compensation power source Vcomp is supplied to the pixel 50 through the power supply line PL1.

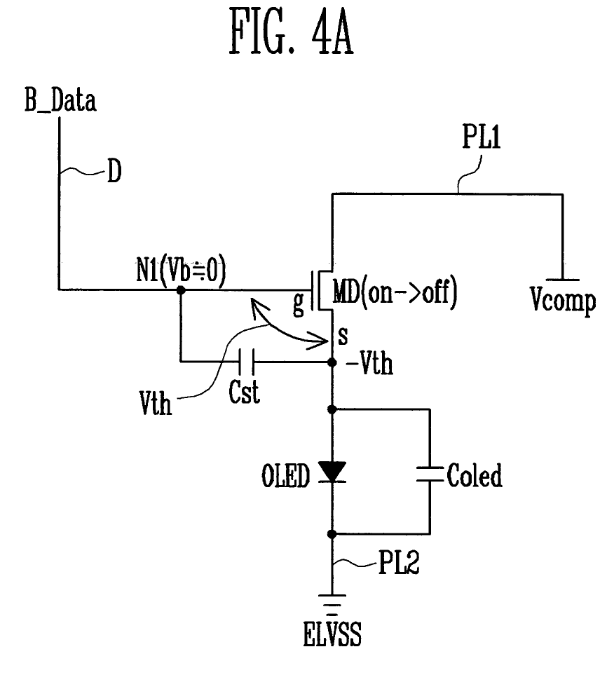

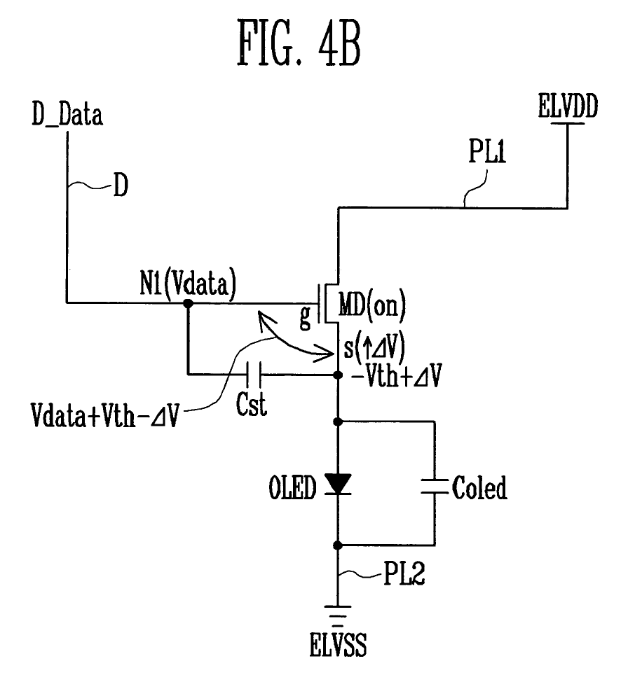

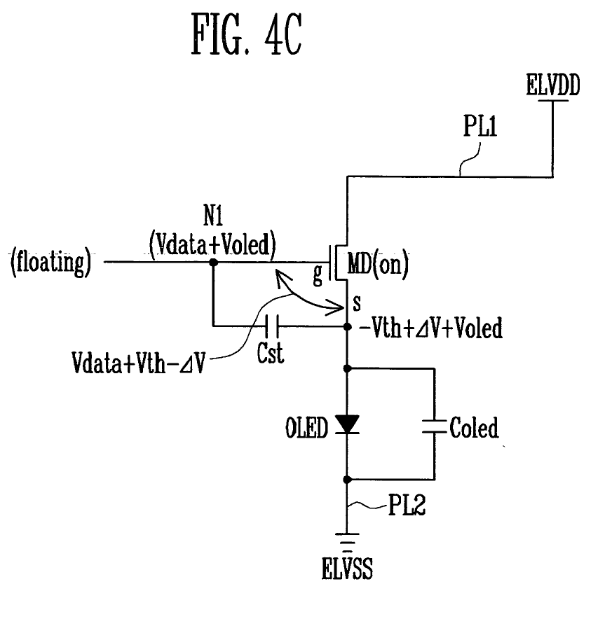

In each of the pixels 50, the switching transistor MS is turned on by a high-level scan signal supplied through a scan line S during a scan period of the corresponding scan line S, and a data line D is coupled to the first node N1 as shown in FIG. 4A. Therefore, a data signal is supplied to the first node N1 from the data line D. However, since a black data signal B_Data is supplied from the data line D in the black frame period P1, the potential at the first node N1 becomes the potential Vb of the black data signal B_Data.

Here, the potential Vb of the black data signal B_Data is potential at which the driving transistor MD can be turned on at an initial time when the black data signal B_Data is supplied from the data line D. The potential Vb of the black data signal B_Data may easily be experimentally determined. For example, the potential Vb of the black data signal B_Data may be set higher by the threshold voltage Vth of the driving transistor MD than that of the compensation power source Vcomp.

When the black data signal B_Data is supplied to the first node N1, the driving transistor MD is turned on. Accordingly, the potential at the source electrode of the driving transistor MD is gradually decreased by the low-potential compensation power source Vcomp. At the time when the voltage difference Vgs between the source and gate electrodes of the driving transistor MD becomes the threshold voltage Vth of the driving transistor MD, the driving transistor MD is turned off.

For convenience of illustration, it is assumed that the potential Vb of the black data signal B_Data is 0V. At the time when the potential at the source electrode of the driving transistor MD becomes −Vth, the driving transistor MD is turned off. The driving transistor MD maintains a turned-off state until the potential at the first node N1 is changed.

At this time, the threshold voltage Vth of the driving transistor MD is stored in the storage capacitor Cst coupled between the gate and source electrodes of the driving transistor MD.

In order to prevent the organic light emitting diode OLED from emitting light during the black frame period P1, the potential of the compensation power source Vcomp may be set lower than the sum of the potential of the ground power source ELVSS and the threshold voltage of the organic light emitting diode OLED. That is, the potential of the compensation power source Vcomp and the ground power source ELVSS may be relatively set so that the organic light emitting diode OLED can maintain an off-state during the black frame period P1. Here, a parasitic capacitor of the organic light emitting diode OLED is equivalently shown as Coled.

Thereafter, transistor M1 of the power control unit 70 is turned on by a high-potential control signal CS during a display frame period P2, and a high-potential pixel power source ELVDD is supplied to the pixel 50 through the power supply line PL1.

The switching transistor MS of the pixel 50 selected by the high-level scan signal supplied for each line is turned on, and a display data signal D_Data is supplied to the first node N1 from the data line D as shown in FIG. 4B.

Accordingly, the potential at the first node N1 is changed into the potential Vdata of the display data signal D_Data. At this time, the potential at the source electrode of the driving transistor MD is changed into a value corresponding to the potential Vdata of the display data signal D_Data due to the charge sharing caused by the storage capacitor Cst and the parasitic capacitor Coled of the organic light emitting diode OLED.

Here, a potential variation at the source electrode of the driving transistor MD is denoted by +ΔV. Then, the potential at the source electrode of the driving transistor MD becomes −Vth+ΔV, and accordingly, the Vgs of the driving transistor MD becomes Vdata+Vth−ΔV. The Vgs of the driving transistor MD is stored in the storage capacitor Cst.

The ΔV is a voltage determined by the display data signal Vdata and mobility. Practically, when the display data signal Vdata is maintained constant, the absolute value of ΔV increases as the mobility increases. Therefore, the value of −ΔV stored in the storage capacitor Cst compensates for mobility of each of the pixels 50. Accordingly, an image having uniform luminance can be displayed without influence of the mobility.

Meanwhile, the organic light emitting diode OLED is continuously turned off at an initial time of the display frame period P2. In this case, driving current supplied from the driving transistor MD flows through the parasitic capacitor Coled of the organic light emitting diode OLED.

After the voltage of Vdata+Vth−ΔV is stored in the storage capacitor Cst, the supply of the scan signal is stopped. Here, the time when the supply of the scan signal is stopped may easily be experimentally determined so that the voltage of Vdata+Vth−ΔV can be stored in the storage capacitor Cst.

When the switching transistor MS is turned off, the gate electrode of the driving transistor MD is set in a floating state as shown in FIG. 4C. Accordingly, a voltage stored in the previous period can be stably maintained in the storage capacitor Cst, regardless of a voltage Voled applied to the organic light emitting diode OLED by the driving current supplied from the driving transistor MD.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device having a pixel unit having a plurality of pixels formed at intersection areas of data and scan lines, a scan driving unit sequentially supplying a scan signal to the scan lines and a data driving unit supplying data signals to the data lines, said organic light emitting display device comprising:
a power supply unit outputting a high-potential pixel power source, a low-potential compensation power source and a low-potential ground power source to drive the pixels; and
a power control unit supplying the low-potential compensation power source supplied from the power supply unit to the pixel unit during a first period of each frame, and supplying the high-potential pixel power source supplied from the power supply unit to the pixel unit during a second period of each of the frames.

2. The organic light emitting display device as claimed in claim 1, wherein the first period is a black frame period of each frame and the second period is a display frame period of each of the frames.

3. The organic light emitting display device as claimed in claim 1, wherein:
the scan driving unit supplies the scan signal to the scan lines in the first and second periods, respectively; and
the data driving unit supplies black data signals to the data lines for each of the first periods and supplies display data signals to the data lines for each of the second periods.

4. The organic light emitting display device as claimed in claim 3, wherein the potential of the black data signal is set higher, by a threshold voltage of a driving transistor provided in each of the pixels, than that of the low-potential compensation power source.

5. The organic light emitting display device as claimed in claim 1, wherein the potential of the low-potential compensation power source is set lower than the sum of the potentials of the low-potential ground power source and a threshold voltage of an organic light emitting diode provided in each of the pixels.

6. The organic light emitting display device as claimed in claim 1, wherein:
the pixel unit is provided in a panel, and the power supply unit and the power control unit are provided in a module provided outside of the panel; and
the power control unit alternately supplies the pixel power source and the low-potential compensation power source through a first power supply line coupled between the pixel unit and the power control unit.

7. The organic light emitting display device as claimed in claim 6, wherein the power control unit simultaneously supplies the pixel power source or the low-potential compensation power source to pixels positioned on each line of the pixel unit through the first power supply line.

8. The organic light emitting display device as claimed in claim 1, wherein:
the power control unit comprises first and second transistors coupled in series between the pixel power source and the low-potential compensation power source from the power supply unit, and receives a common control signal through gate terminals of the first and second transistors; and
the first and second transistors are set as opposite types of transistors and are alternately turned on in response to the control signal.

9. The organic light emitting display device as claimed in claim 8, wherein the first and second transistors are metal oxide semiconductor field-effect transistors (MOSFETs).

10. The organic light emitting display device as claimed in claim 1, wherein each of the pixels comprises:
an organic light emitting diode coupled between a first power supply line and a second power supply line, the first power supply line being supplied with the pixel power source or the low-potential compensation power source from the power control unit, and the second power supply line being supplied with the low-potential ground power source from the power supply unit;
a driving transistor coupled between the first power supply line and the organic light emitting diode;
a storage capacitor coupled between gate and source electrodes of the driving transistor; and
a switching transistor coupled between the gate electrode of the driving transistor and a data line, the switching transistor having a gate electrode coupled to a scan line.

11. The organic light emitting display device as claimed in claim 1, wherein the second period is subsequent to the first period.

12. A method of driving an organic light emitting display device, comprising:
storing a threshold voltage of a driving transistor in each of the pixels while supplying a scan signal, a black data signal, a ground power source and a compensation power source to pixels during a first period of a frame; and
displaying an image corresponding to the display data signal while supplying a scan signal, a display data signal, the ground power source and a high-potential pixel power source to the pixels during a second period of the frame.

13. The method as claimed in claim 12, wherein the compensation power source or the pixel power source is simultaneously supplied to the pixels from the outside of a panel.

14. The method as claimed in claim 12, wherein the ground power source and the compensation power source are each set as low-potential power sources, and the potential of the ground power source and the compensation power source is relatively set so that an off-state is maintained in an organic light emitting diode provided in each of the pixels during the first period.

15. The method as claimed in claim 12, wherein a potential of the black data signal is set higher, by a threshold voltage of a driving transistor provided in each of the pixels, than a potential of the compensation power source.

16. The method as claimed in claim 12, wherein the first period is a black frame period of each frame and the second period is a display frame period of each of the frames.

17. An organic light emitting display device, comprising:
a pixel unit having a plurality of pixels formed at intersection areas of data and scan lines;
a scan driving unit sequentially supplying a scan signal to the scan lines;
a data driving unit supplying data signals to the data lines;
a power supply unit outputting a pixel driving power source, a compensation power source and a low-potential power source to drive the pixels; and
a power control unit supplying the compensation power source supplied from the power supply unit to the pixel unit during a black frame period of each frame, and supplying the pixel driving power source supplied from the power supply unit to the pixel unit during a display frame period of each of the frames.

18. The organic light emitting display device as claimed in claim 17, wherein a potential of the compensation power source is set lower than a sum of the potentials of the low-potential power source and a threshold voltage of an organic light emitting diode provided in each of the pixels.

19. The organic light emitting display device as claimed in claim 18, wherein each of the pixels comprises:
a driving transistor coupled between the first power supply line and said organic light emitting diode, the first power supply line being sequentially supplied with the pixel driving power source and the compensation power source from the power control unit;
said organic light emitting diode being coupled between said driving transistor and a second power supply line, the second power supply line being supplied with the low-potential power source from the power supply unit;
a storage capacitor coupled between gate and source electrodes of the driving transistor; and
a switching transistor coupled between the gate electrode of the driving transistor and a data line, the switching transistor having a gate electrode coupled to a scan line.

20. The organic light emitting display device as claimed in claim 19, wherein:
the power control unit comprises first and second transistors coupled in series between the pixel driving power source and the compensation power source from the power supply unit, the power control unit receiving a common control signal through gate terminals of the first and second transistors; and
the first and second transistors are set as opposite types of transistors and are alternately turned on in response to the control signal to sequentially supply the pixel driving power source and the compensation power source from the power control unit to the first power supply line.
